(19) United States
(12) Patent Application Publication
(10) Pub. No.: US 2006/0003627 A1
(43) Pub. Date: Jan. 5, 2006

(54) Fused battery terminal connector

(76) Inventor: Erik Freitag, Arlington Heights, IL (US)

Correspondence Address: Daniel N. Christus, Esq.;Wallenstein Wagner & Rockey, Ltd., 53rd Floor, 311 South Wacker Drive, Chicago, IL, 60606-6630, US

(21) Appl. No.: 10/883,136

(22) Filed: Jul. 1, 2004

(51) Int. Cl. H01R 11/00; H01R 4/28

(52) U.S. Cl. 439/504; 429/121; 439/754

(57) ABSTRACT

A battery terminal connector having at least one ferrule at one end of the connector; a body portion at the other end of the connector; a elongated strap between the ferrule and the body portion; and a removable fuse, having two terminals, and positioned between the ferrule and the body portion. The connector preferably has an insulator positioned adjacent the elongated strap, and a spindle arising from a generally flat panel upon which the insulator is positioned.

### TECHNICAL FIELD

This invention is directed to a battery terminal connector, and more particularly to a battery connector that includes a body portion, a ferrule, and an elongated strap securing the body portion to the ferrule. The battery terminal connector may also include at least one fuse, an optional second fuse, and a jump start terminal along the elongated strap.

### BACKGROUND OF THE INVENTION

Storage batteries of the type used in automobiles, trucks and the like, generally have a terminal post made of a lead alloy material with a cylindrical or frusto-conical shape. The battery is connected to the components of the vehicle electrical system by a battery cable assembly. The cable assembly has connectors which clamp to the battery posts, providing a secure electrical and mechanical connection.

A conventional connector for connecting cables to the battery is a molded, generally U-shaped device with a bolt passing through outwardly projecting yoke-like arms for securely clamping the connector to the battery post. The connector may also be a stamped metal battery terminal connector, fabricated from sheet metal.

U.S. Pat. No. 5,733,152 (“the '152 patent”) is directed to a battery terminal connector. The '152 patent is owned by the assignee of the present application, and relates to a battery terminal connector which permits improved mechanical and electrical connection to a battery terminal post. The connector of the '152 patent has enhanced resistance to rotation when connected to a battery terminal post. That connector is also economical to manufacture, and is adaptable for automated assembly and production. An additional advantage of this connector is that it is adaptable to different automobile models and batteries.

U.S. Pat. No. 5,879,202 (“the '202 patent”) is also directed to a battery terminal connector. This connector is of the type that permits tightening onto the battery post using a threaded nut that is positioned above, rather than on the side of, the connector. As a result, especially in tight, confining areas found under the hoods of modern automobiles, the nut is more easily accessed during installation of the '202 connector, as compared to the accessibility of the threaded nuts that are secured to the sides of many prior art connectors.

U.S. patent application Ser. No. 10/809,168 (“the '168 application”) is directed to a fused battery terminal connector. The '168 application is owned by the assignee of the present application, and discloses a battery terminal connector having a ferrule at one end of the connector, and a body portion at the other end of the connector. Between the ferrule and the body portion is a generally flat base portion that is designed to accommodate, at the generally flat base portion, a removable fuse. An insulator, which is positioned adjacent the generally flat base portion of the connector, permits a clamping nut to be handled by the individual changing the fuse with a lowered risk of shock. A spindle may also arise from the generally flat base upon which the insulator is positioned. The spindle and the insulator may be integrally secured to a bracket. The bracket may be made of an insulating material, and have a generally C-shaped profile.

Additional relevant prior art references include U.S. Pat. Nos. 6,250,973, 5,941,738, 5,879,202, 5,800,219, 5,738,552, 5,711,688, 5,672,442, 5,599,210, 5,316,505, 4,354,726, 4,063,794, 4,054,355, and 3,568,138. None of these patents, however, alone or in combination, disclose the present invention.

### SUMMARY OF THE INVENTION

The invention is a battery terminal connector. The battery terminal connector includes at least a body portion, a ferrule or grip, and an elongated strap securing the body portion to the ferrule.

The elongated strap has a length of at least two to three times the combined lengths of the body portion and the ferrule. In fact, the elongated strap may have a length substantially longer than two to three times the combined lengths of the body portion and the ferrule. The elongated strap can have whatever length is necessary to accomplish the objects of the invention.

The elongated strap can be straight, but can also be angular. As but one example of an angular strap, the elongated strap may have a substantially L-shaped profile. More particularly, the elongated strap with the substantially L-shaped profile can have a right angle between the two legs that form the L.

The battery terminal connector may include, upon its elongated strap, a raised portion for permitting jump starting of the vehicle to which the battery terminal connector of the invention is secured.

Preferably, the battery terminal connector includes at least a first removably-mounted fuse that is positioned between the ferrule and the body portion. In yet another embodiment, a second removably-mounted fuse is positioned between the ferrule and the body portion.

### BRIEF DESCRIPTION OF THE DRAWINGS

FIG. 1 is a perspective view of one embodiment of a fused battery terminal connector of the invention.

FIG. 2 is a top view of the fused battery terminal connector of FIG. 1.

FIG. 3 is a side view of the embodiment of the connector of FIGS. 1 and 2.

FIG. 4 is an end view, taken along the right side, of the fused battery terminal connector of FIG. 1.

FIG. 5 is a partial sectional view of the battery terminal connector of FIG. 1, taken along lines 5-5 of FIG. 2.

FIG. 6 is a partial sectional side view of the embodiment of FIG. 2, taken along lines 6-6 of FIG. 2.

FIG. 7 is partial sectional view, primarily of the C-shaped bracket or insulator and spindle, of the fused battery terminal connector of FIG. 1, taken along lines 7-7 of FIG. 3.

FIG. 8 is a partial sectional view of the elongated strap portion of the fused battery terminal connector of FIG. 1, taken along lines 8-8 of FIG. 3.

FIG. 9 is a partial sectional view of the crimp portion of the fused battery terminal connector of FIG. 1, taken along lines 9-9 of FIG. 3.

### DETAILED DESCRIPTION

There are many possible embodiments of this invention. The drawings and description below describe in detail a preferred embodiment of the invention. It should be understood that the present disclosure is to be considered as an example of the principles of the invention. The disclosure is not intended to limit the broad aspect of the invention to the illustrated embodiment.

Referring now to FIG. 1, the invention is a battery terminal connector 10. The battery terminal connector 10 includes a main body portion 12.

The construction of some portions of the novel battery terminal connector 10 shown in FIG. 1 is similar to the construction of battery terminal connectors of the prior art. The details of such construction are disclosed in some detail in the specification of the co-pending U.S. application Ser. No. 10/177,289 of the assignee, and of assignee's already issued U.S. Pat. No. 5,733,152. The disclosures of that application and that patent are incorporated by reference into this specification.

As may be seen in this FIG. 2, this body portion 12 is at one of the lateral ends of the connector 10, and has a length L1. In the current preferred embodiment, the length L1 of this body portion 12 is approximately 1½ inches. The body portion 12 is fitted over either the negative (−) or positive (+) frusto-conical shaped terminal post (not shown) of a twelve-volt automotive storage battery.

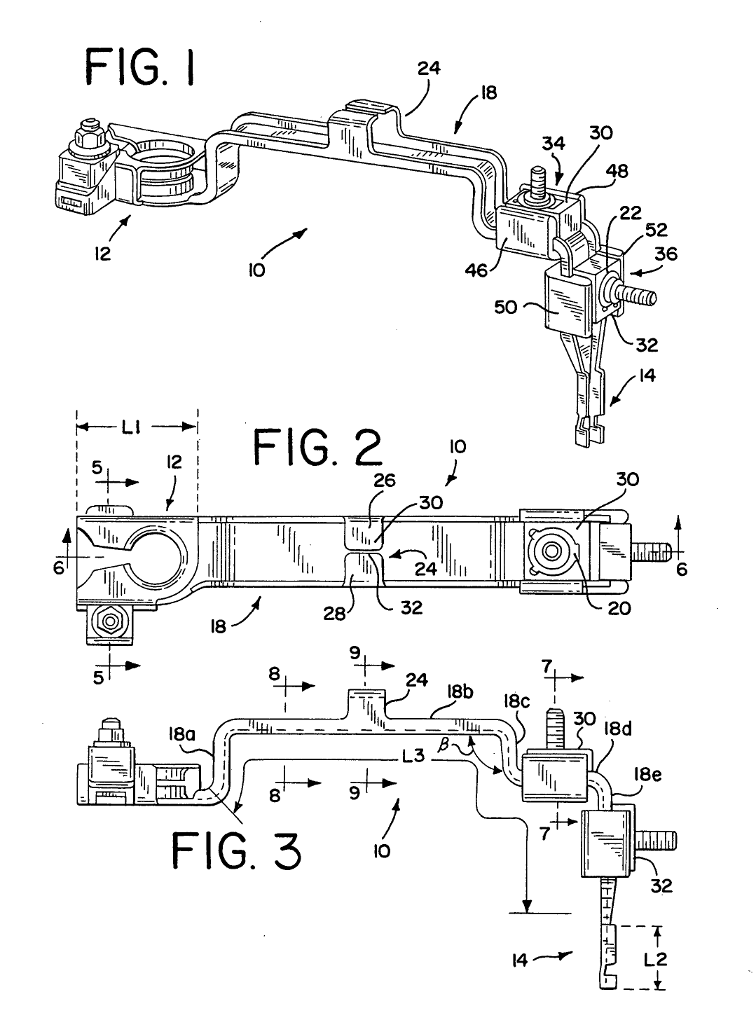

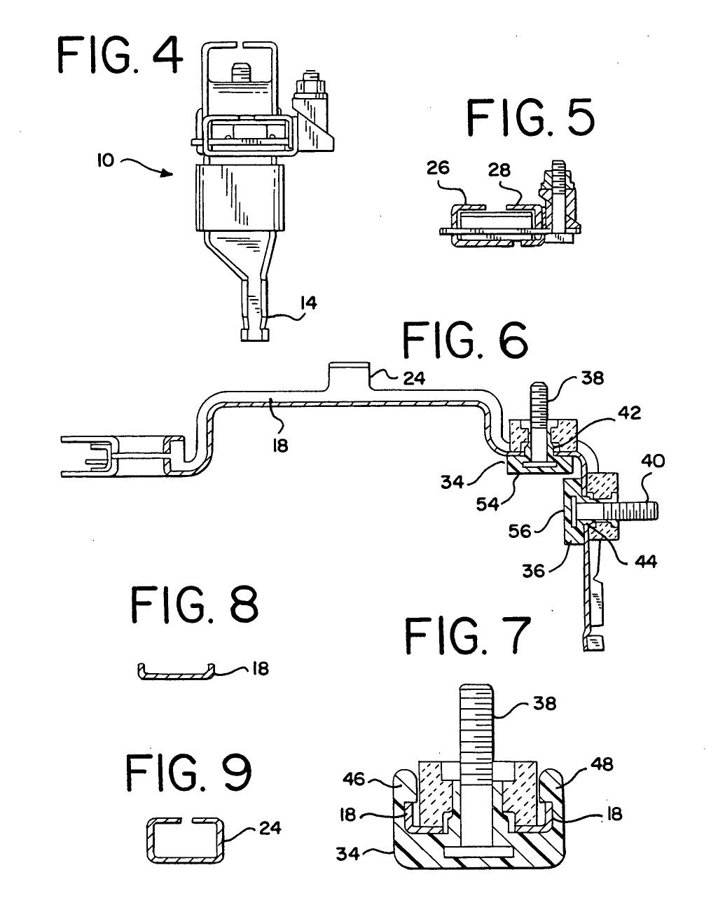

At its opposite lateral end, this battery terminal connector 10 includes a grip or ferrule 14. As may be seen in FIG. 3, this ferrule has a length L2. In the current preferred embodiment, the length L2 of this ferrule 14 is approximately ⅞ inch. The ferrule 14 is adapted for connecting and securing the battery cable (not shown) to the connector 10. Particularly, a portion of insulation adjacent one end of the battery cable is removed, exposing the underlying copper core of the cable. The exposed end of the battery cable is placed onto the ferrule 14, and the opposing wings of the ferrule 14 are crimped over that copper core. As a result of this crimping, the exposed end of the battery cable is gripped tightly by the ferrule 14. In this way, electrical current can travel, for example, from the positive (+) battery post of the automotive storage battery, through the battery cable, and to the starter motor of the vehicle.

The battery terminal connector 10 is typically made of a single piece of copper, copper alloy, or any other single, flat piece of conductive material, and preferably a conductive metal. Typically, a blank is stamped from a thin, single piece of copper or copper alloy. After the creation of a stamped blank, that blank may be mechanically folded, in a manner well-known in the art, until it attains the shape of the finished product shown in FIG. 1.

Referring again to this FIG. 1, the body portion 12 and the ferrule 14 are connected to each other by an elongated strap 18. Because this elongated strap 18 is formed from the same conductive, stamped blank as the body portion 12 and ferrule 14, the elongated strap 18 is conductive, and is of one piece with the body portion 12 and the ferrule 14.

Auto manufacturers and designers are constantly dealing with and resolving design compromises. For example, in their on-going attempts to reduce the fuel consumption of vehicles, designers are faced with the design paradox of providing maximum passenger and cargo room, while making smaller, increasingly lightweight vehicles. As a result of these design constraints, newer automobiles frequently have smaller engine compartments.

The connector 10 of the invention and its elongated strap 18 provide solutions to some of these design compromises, and provide a great deal of flexibility to manufacturers of automobiles. For example, as noted above, there is often less engine bay space under the hood of modern automobiles. The main body portion 12 and ferrule 14 of most prior art connectors are in close proximity to each other. Some car manufacturers currently place their batteries in very close proximity to side walls of the engine compartment, or to other structures of components within the engine compartment. As a result, many conventional connectors are unacceptable for use with such automobiles.

To resolve this problem, the inventors designed the present connector 10 so that the body portion 12 and ferrule 14 are separated by the elongated strap 18. In fact, the body portion 12 and the ferrule 14 can be separated by as much distance as is necessary to accommodate the design needs of the auto manufacturer or designer.

For example, the elongated strap 18 can have a length L3 that may be two times the combined length (L1+L2) of the body portion 12 and the ferrule 14. Alternatively, the elongated strap 18 can have a length L3 that can be three times the combined length (L1+L2) of the body portion 12 and ferrule 14. In fact, however, the elongated strap 18 can be of any suitable length L3, as long as that length L3 is at least two times the combined length (L1+L2) of the body portion 12 and the ferrule 14. The maximum length L3 of the elongated strap 18 is essentially unlimited, i.e., it shall be limited only by the design needs of the automotive engineer.

The elongated strap 18 may include a single leg, or two or more legs. In the embodiment shown in the drawings, and as may best be seen in FIG. 3, the elongated strap may be comprised of five segments. There are three vertical segments, including vertical segments 18a, 18c, and 18e. There are two horizontal segments, including horizontal segments 18b and 18d. The total length of these five segments is approximately 7½ inches. Because the combined length (L1+L2) of the body portion 12 and ferrule 14 is 2⅜ inches, the total length L of the elongated strap of FIG. 3 is approximately 3.16 times the combined length of the body portion 12 and ferrule 14.

In another embodiment, it is possible that the elongated strap 18 could be straight, or have two, or three or four or more segments or legs, rather than five segments or legs. For example, referring again to FIG. 3, another embodiment could have two legs comprising horizontal segment 18b and vertical segment 18c. In such an embodiment, the vertical segment 18c could be longer than that shown, and sufficiently long to extend to the ferrule 14. In addition, as may be seen in FIG. 3, the angle between these segments or legs 18b and 18c is a 90 degree angle, or a right angle β. These two legs 18b and 18c, coming together at this right angle β, create an elongated strap 18 having a preferred L-shaped profile.

Referring now to FIGS. 2, 3, and 6, the elongated strap 18 of the connector 10 includes a raised portion. In this preferred embodiment, the raised portion is a crimp 24. Here, this crimp 24 is formed by manipulating or turning a pair of tabs 26 and 28 that are a part of the stamped blank 16. Particularly, tabs 26 and 28 are bent approximately 90° upwardly relative to the horizontal plane of the stamped blank, and then are bent an additional 90° inwardly, so that their ends 30 and 32, respectively, face each other, and those ends 30 and 32 are spaced closely from each other.

When the crimp 24 is in its final form, as may be seen in FIGS. 2, 3, and 6, it serves as a point of attachment for a clamp at the ends of automotive jumper cables. One clamp at one end of the jumper cables is attached to the crimp 24, while a second clamp at this same end of the jumper cables is attached to a ground of the car whose battery has been discharged. Meanwhile, the clamps at the other end of the jumper cables are attached to the vehicle with the “good” battery. The crimp 24 thus provides an ideal, easily accessible place for jumping an automobile with a discharged battery. The provision of such an easily accessible place for jump starting is again important, in view of the space limitations of the typical engine compartment of a modern automobile.

As may best be seen in FIG. 2, the battery terminal connector 10 includes a first removably mounted fuse 30. This first removably mounted fuse 30 is positioned on the segment 18d of the elongated strap 18.

As may best be seen in FIG. 3, the battery terminal connector 10 also includes a second removably mounted fuse 32. This second removably mounted fuse 32 is preferably positioned on the segment 18e of the elongated strap 18.

These removable fuses 30 and 32 are similar to the fuses 24 disclosed in the present assignee's co-pending U.S. application Ser. No. 10/809,160, filed on Mar. 25, 2004. The disclosures relating to those fuses 24 are incorporated herein by reference.

Referring now to FIGS. 6 and 7, the connector 10 of the invention may include two C-shaped brackets 34 and 36, each of which is separable from the battery terminal connector 10. As with the C-shaped bracket disclosed in the present assignee's co-pending U.S. patent application Ser. No. 10/809,160, each of the C-shaped brackets 34 and 36 include integrally formed metal spindles 38 and 40, respectively. The C-shaped brackets 34 and 36 and their integrally formed metal spindles 38 and 40 are connected to the battery terminal connector 10 by passing those threaded spindles 38 and 40 through separate orifices 42 and 44, respectively.

Unlike the metallic conducting spindles 38 and 40, the C-shaped brackets 34 and 36 are made of an insulating material. The preferred insulating material is a petroleum based polymer, and the most preferred polymer is polyethylene.

Each of the brackets 34 and 36 includes side walls. Bracket 34 includes side walls 46 and 48, while bracket 36 includes side walls 50 and 52.

When the C-shaped brackets 34 and 36 are brought into engagement with the battery terminal connector 10, the brackets 34 and 36 are tightly held together with that connector 10 by virtue of a friction fit. Because of this friction fit, no fasteners are necessary to retain the connector 10 with the C-shaped brackets 34 and 36.

This friction fit results from two main factors. The first of these factors is a tight fit between orifices 42 and 44 and the C-shaped brackets 34 and 36. The second of these factors is a relatively tight fit between the side walls 46 and 48 of the C-shaped bracket 34 (and the side walls 50 and 52 of the C-shaped bracket 36) and the sides of the elongated strap 18 of the battery terminal connector 10.

The threaded spindles 38 and 40 are molded into the C-shaped brackets 34 and 36, in a manner well-known in the art. As indicated above, unlike the C-shaped brackets 34 and 36, the threaded spindles 38 and 40 are made of a conducting material, preferably a metal material. The spindles 38 and 40 are molded into brackets 34 and 36, and arise from generally flat support panels 54 and 56 of the brackets 34 and 36. The integral securement typical of the spindles 38 and 40 to the brackets 34 and 36 may best be seen in FIG. 7.

It will be understood that a threaded clamping nut (not shown) may be secured to either of the threaded spindles 38 and 40 to retain the removable fuses 30 and 32 to the battery terminal connector 10. If the vehicle owner or service technician discovers through a visual inspection that either of the fuses 30 and 32 have blown, the appropriate threaded nut may be easily removed, the blown fuse may be removed, and the blown fuse may be replaced with a new fuse. The appropriate threaded nut may then be replaced onto the spindle 38 or 40 to secure the new fuse that replaces blown fuse.

Referring now to FIG. 7, the C-shaped bracket 34 is indicated by large-scale, downwardly-sloping cross-hatching. As can be seen from this FIG. 7, this bracket 34 insulates the threaded spindle 38 from the elongated strap 18. As a result, contact is prevented between the spindle 38 and the elongated strap 18. Thus, no current may pass from the connector 10 into the spindle 38. This is important, as the threaded clamping nut (not shown) is threadably engaged to the spindle 38. Thus, any current that would pass through the spindle 38 could also pass through the threaded clamping nut. It follows that because the C-shaped bracket 34 prevents current from passing into the spindle 38, no current can pass through the threaded clamping nut. In this way, when a user through visual inspection determines that either the first removably mounted fuse 30 or the second removably mounted fuse 32 need to be replaced, he may grasp the threaded clamping nut and ordinarily not be subjected to electrical shock.

The first removably mounted fuse 30 and the second removably mounted fuse 32 can protect any of a number of different vehicle electrical components. One example of such a component is the power distribution box. Another example of such a component is an alternator. An insulated conducting cable, having at one of its ends a circular terminal or eyelet (not shown), permits the flow of electrical current between the connector 10 and the power distribution box or alternator. The ring-shaped eyelet is sized so that it lays flat upon and engages the entire top surface of each of the conducting terminals 20 and 22 of the respective fuses 30 and 32. The eyelet is secured to the terminals by the threaded clamping nut referred to above.

Accordingly, it may be appreciated from the above description that the present invention is a device which provides easy access by the vehicle owner to fuses that, in prior art devices, are often inaccessible. As a result, the invention enables the fuse to be readily replaced by the vehicle owner or a service technician.

It may also be appreciated from the above description that the present invention permits the vehicle owner to readily see the fuse, and thereby visually establish that the fuse has in fact blown. Thus, the present invention permits the owner to engage is such replacement, in the event that the owner's visual inspection of that fuse establishes that the fuse has blown. This eliminates the need for the owner to drive or tow his vehicle to a service or repair facility. Moreover, by virtue of his ability to ascertain the nature of the problem, and to quickly and easily remedy that problem, the vehicle owner can avoid being stranded in an inoperable vehicle. Unlike some prior art devices, which provide for permanent securement of a fuse or fusible link to a cable, replacement of a blown fuse can be readily accomplished without replacement of the entire fuse/cable assembly.

Further, the present invention permits automobile designers to connect battery connectors in low-space underhood environments, enabling the body portion 12 and the ferrule 14 to be separated as much as is necessary to accommodate the design needs of the auto manufacturer.

Further, the crimp provides an ideal, easily accessible place for jumping an automobile with a discharged battery.

It is understood that, given the above description of the embodiments of the invention, various modifications may be made by one skilled in the art. Such modifications are intended to be limited only by the scope of the below claims.

What is claimed is:

1. A battery terminal connector, the battery terminal connector including at least:
(a) a body portion;
(b) a ferrule; and
(c) an elongated strap securing the body portion to the ferrule, said elongated strap having a length at least two times the combined lengths of the connector and the grip.

2. The battery terminal connector of claim 1, wherein the elongated strap has a length at least three times the combined lengths of the connector and the grip.

3. The battery terminal connector of claim 1, wherein the elongated strap has a substantially L-shaped profile.

4. The battery terminal connector of claim 2, wherein the elongated strap has a substantially L-shaped profile.

5. The battery terminal connector of claim 1, wherein the elongated strap includes a raised portion for permitting jump starting of the vehicle to which the battery terminal connector is secured.

6. The battery terminal connector of claim 5, wherein the raised portion comprises a crimp.

7. The battery terminal connector of claim 1, further comprising a removably-mounted fuse, and positioned between the ferrule and the body portion.

8. The battery terminal connector of claim 7, further comprising a second removably-mounted fuse, positioned between the ferrule and the body portion.
